(19) United States
(12) Patent Application Publication
(10) Pub. No.: US 2023/0152441 A1
(43) Pub. Date: May 18, 2023

(54) OBJECT DETECTION DEVICE, INFORMATION PROCESSING DEVICE, AND OBJECT DETECTION METHOD

(71) Applicant: SONY SEMICONDUCTOR SOLUTIONS CORPORATION, KANAGAWA (JP)

(72) Inventor: YUJI HANDA, KANAGAWA (JP)

(21) Appl. No.: 17/907,592

(22) PCT Filed: Feb. 19, 2021
(86) PCT No.: PCT/JP2021/006484

§ 371 Date: Sep. 28, 2022

(30) Foreign Application Priority Data
Apr. 13, 2020 (JP) 2020-071594

(51) Int. Cl. G01S 13/86; G01S 13/42; G01S 13/931; G06T 7/73

(52) U.S. Cl. CPC G01S 13/867; G01S 13/42; G01S 13/931; G06T 7/74; G06T 2207/30252

(57) ABSTRACT

To provide an object detection device, an information processing device, and an object detection method capable of accurately detecting an object.

An object detection device according to the present disclosure includes a radar that transmits a radio wave to a first area and detects a detection target candidate present in the first area, an imaging section that images the first area and generates image data, an identification section that identifies a detection target from a plurality of the detection target candidates on the basis of the image data, and a radar control section that controls the radar so as to irradiate a second area including the detection target and narrower than the first area with a radio wave.

### TECHNICAL FIELD

The present disclosure relates to an object detection device, an information processing device, and an object detection method.

### BACKGROUND ART

Conventionally, the automatic traveling control system (Adoptive Cruise Control (ACC)) uses a millimeter wave radar or an image sensor using a camera in order to recognize an object in front (in back or on the side). The millimeter wave radar accurately measures a distance to an object, but it is difficult to accurately recognize the shape (size and width) of the object. On the other hand, the image sensor accurately recognizes the shape and size of the object, but it is difficult to accurately perform distance measurement.

### CITATION LIST

### Patent Document

Patent Document 1: Japanese Patent Application Laid-Open No. 2001-99930

### SUMMARY OF THE INVENTION

### Problems to be Solved by the Invention

Therefore, a device in which a millimeter wave radar and a camera are combined is conceivable (Patent Document 1).

However, even if the measurement result detected by the millimeter wave radar and the measurement result detected by the camera are simply combined, the accuracy of the object detection is insufficient, and it is desired to detect an object more accurately.

Therefore, the present disclosure provides an object detection device, an information processing device, and an object detection method capable of accurately detecting an object.

### Solutions to Problems

An object detection device according to the present embodiment includes a radar that transmits a radio wave to a first area and detects a detection target candidate present in the first area, an imaging section that images the first area and generates image data, an identification section that identifies a detection target from a plurality of the detection target candidates on the basis of the image data, and a radar control section that controls the radar so as to irradiate a second area including the detection target and narrower than the first area with a radio wave.

The radar may transmit a radio wave to the first area and detect a transmission and reception point of a reflected radio wave, and a data processing section that clusters the transmission and reception point to generate the detection target candidate may further be included.

A coordinate transformation section that transforms a direction and a relative distance of the detection target candidate with respect to the radar into coordinates of the detection target candidate on the image data, and an extraction section that extracts an image portion of the detection target candidate from the image data on the basis of coordinates of the detection target candidate on the image data may further be included, in which the identification section may identify whether or not the detection target candidate is the detection target using the image portion of the detection target candidate extracted, and the radar control section may control the radar in such a manner that the detection target is located in the second area on the basis of a direction and a distance of the detection target candidate determined as the detection target.

A database that stores a reference image serving as a reference for collation in order to specify the detection target may further be included, in which the identification section may compare an image portion of the detection target candidate extracted with the reference image and identify the detection target candidate having a similar reference image as the detection target.

The radar control section may control the radar to be switched between a first mode in which the first area is irradiated with a radio wave and a second mode in which the second area is irradiated with a radio wave.

The radar control section may control the radar so as to irradiate the detection target identified in the first mode with a radio wave in the second mode next to the first mode.

The radar control section may alternately repeat the first mode and the second mode.

An information processing device according to the present disclosure includes an identification section that identifies, on the basis of a detection target candidate detected by transmitting a radio wave from a radar to a first area and image data obtained from an imaging section, a detection target from a plurality of the detection target candidates, and a radar control section that controls the radar so as to irradiate a second area including the detection target and narrower than the first area with a radio wave.

A data processing section that transmits a radio wave from the radar to the first area and clusters a transmission and reception point of a reflected radio wave to generate the detection target candidate may further be included.

A coordinate transformation section that transforms a direction and a relative distance of the detection target candidate with respect to the radar into coordinates of the detection target candidate on the image data, and an extraction section that extracts an image portion of the detection target candidate from the image data on the basis of coordinates of the detection target candidate on the image data may further be included, in which the identification section may identify whether or not the detection target candidate is the detection target using the image portion of the detection target candidate extracted, and the radar control section may control the radar in such a manner that the detection target is located in the second area on the basis of a direction and a distance of the detection target candidate determined as the detection target.

A database that stores a reference image serving as a reference for collation in order to specify the detection target may further be included, in which the identification section may compare an image portion of the detection target candidate extracted with the reference image and identify the detection target candidate having a similar reference image as the detection target.

The radar control section may control the radar to be switched between a first mode in which the first area is irradiated with a radio wave and a second mode in which the second area is irradiated with a radio wave.

The radar control section may control the radar so as to irradiate the detection target identified in the first mode with a radio wave in the second mode next to the first mode.

The radar control section may alternately repeat the first mode and the second mode.

An object detection method using an object detection device that includes a radar that transmits a radio wave, an imaging section that images an image, and an information processing device that processes detection information from the radar and image data from the imaging section to control the radar, the object detection method including transmitting a radio wave to a first area and detecting a detection target candidate present in the first area, imaging the first area and generating image data, identifying a detection target from a plurality of the detection target candidates on the basis of the image data, and controlling the radar so as to irradiate a second area including the detection target and narrower than the first area with a radio wave.

Detecting the detection target candidate may include transmitting a radio wave to the first area and detecting a transmission and reception point of a reflected radio wave, and clustering the transmission and reception point to generate the detection target candidate.

Identifying the detection target may include transforming a direction and a relative distance of the detection target candidate with respect to the radar into coordinates of the detection target candidate on the image data, extracting an image portion of the detection target candidate from the image data on the basis of coordinates of the detection target candidate on the image data, and identifying whether or not the detection target candidate is the detection target using the image portion of the detection target candidate extracted, and controlling the radar may include controlling the radar in such a manner that the detection target is located in the second area on the basis of a direction and a distance of the detection target candidate determined as the detection target.

The object detection device may further include a database that stores a reference image serving as a reference for collation in order to specify the detection target, and identifying the detection target may include comparing an image portion of the detection target candidate extracted with the reference image, and identifying the detection target candidate having a similar reference image as the detection target.

Controlling the radar may include controlling the radar to be periodically and alternately switched between a first mode in which the first area is irradiated with a radio wave and a second mode in which the second area is irradiated with a radio wave.

Controlling the radar may include irradiating the detection target identified in the first mode with a radio wave in the second mode next to the first mode.

### BRIEF DESCRIPTION OF DRAWINGS

FIG. 1 is a block diagram depicting a configuration example of an object detection device according to a first embodiment.

FIG. 2 is a flowchart depicting an example of an object detection method according to the present disclosure.

FIG. 3 is a schematic diagram depicting an irradiation range of radio waves from a millimeter wave radar.

FIG. 4 is a timing chart depicting a performance pattern of a wide-band mode and a narrow-band mode.

FIG. 5 is a timing chart depicting another performance pattern of a wide-band mode and a narrow-band mode in a second embodiment.

FIG. 6 is a block diagram depicting an example of schematic configuration of a vehicle control system as an example of a mobile body control system to which the technology according to an embodiment of the present disclosure can be applied.

FIG. 7 is a diagram depicting an example of the installation position of an imaging section.

### MODE FOR CARRYING OUT THE INVENTION

Hereinafter, preferred embodiments of the present disclosure will be described in detail with reference to the accompanying drawings. Note that, in the present specification and the drawings, components having substantially the same functional configuration are denoted by the same reference numerals, and redundant description is omitted.

### First Embodiment

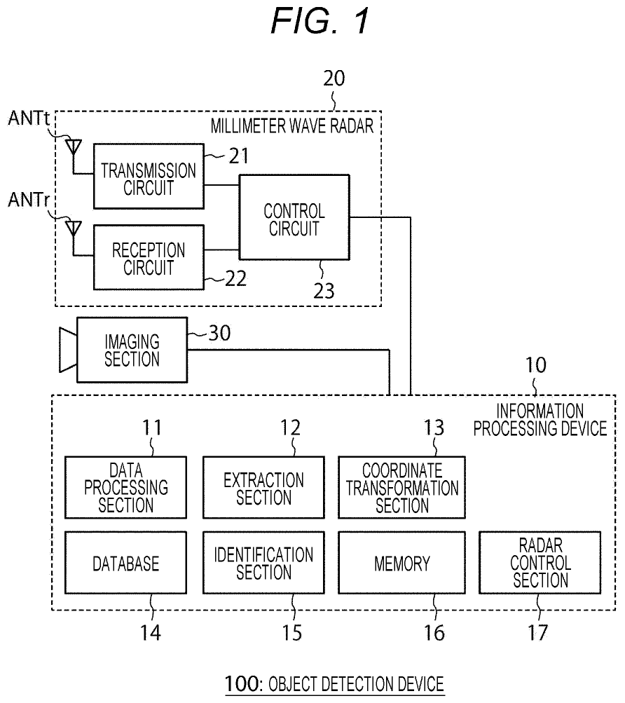

FIG. 1 is a block diagram depicting a configuration example of an object detection device according to a first embodiment. An object detection device 100 is a device used in an automatic traveling control system, but is not limited thereto, and can also be applied to object detection in a monitoring device system or the like. Hereinafter, an example in which the present disclosure is applied to an automatic traveling control system of an automobile will be described, but the application example of the present disclosure is not limited thereto.

The object detection device 100 includes an information processing device 10, a millimeter wave radar 20, and an imaging section 30.

The millimeter wave radar 20 includes a transmission circuit 21, a reception circuit 22, a control circuit 23, a transmission antenna ANTt, and a reception antenna ANTr. The transmission circuit 21 is a circuit that transmits radio waves from the transmission antenna ANTt. The reception circuit 22 is a circuit that receives radio waves reflected from an object via the reception antenna ANTr. That is, radio waves are transmitted from the transmission circuit 21, reflected by the object, and then received by the reception circuit 22.

The control circuit 23 controls the strength (output) of radio waves transmitted from the transmission circuit 21, the radiation angle (directivity) of the transmission antenna ANTt, a transmission and reception timing, and the like. As a result, the control circuit 23 can control the distance at which the object can be detected, and controls a radio-wave irradiation area (wide-band, narrow-band, or the like). That is, the control circuit 23 can control the scanning range of the radio wave and change an object detection area.

The millimeter wave radar 20 transmits a millimeter radio wave forward, receives a reflected wave, and detects information of an object that has generated the reflected wave. The millimeter wave radar 20 can accurately measure, for example, the distance, angle, and speed of an object, and is less affected by rain, fog, or the like. On the other hand, it is difficult for the millimeter wave radar 20 to accurately measure, for example, the size and shape of the object. The millimeter wave radar 20 detects the signal intensity from the received millimeter wave signal, and obtains the relative distance, direction (angle), relative speed, and the like of the object. The relative distance and angle of the object indicate the position (polar coordinates) of the detected object. The relative speed is the relative speed of the object with respect to the millimeter wave radar 20.

The millimeter wave radar 20 detects the relative distance, the direction, the relative speed, and the signal intensity of the object by transmission and reception of radio waves for each point (transmission and reception point) at which the radio wave is transmitted and received. The millimeter wave radar 20 or the information processing device 10 then clusters an aggregate of a plurality of transmission and reception points having substantially equal relative distances, relative speeds, and signal intensities by using the relative distances, directions, relative speeds, and signal intensities of the plurality of transmission and reception points, and detects the aggregate as an object. That is, the millimeter wave radar 20 detects the object as an aggregate of a plurality of transmission and reception points obtained by transmission and reception of radio waves. The millimeter wave radar 20 periodically transmits radio waves, and detects the presence or absence of an object on the basis of signal intensity at the transmission and reception point of the reflected radio wave.

Here, the radio wave detected by the millimeter wave radar 20 may detect an aggregate of transmission and reception points having substantially equal relative distances, relative speeds, and signal intensities for some reason even if an object is not actually present. In such a case, the millimeter wave radar 20 or the information processing device 10 detects the aggregate of the transmission and reception points as an object. In addition, even if the object is present, an object that is not a detection target may be included. For example, in a case where an obstacle such as another vehicle traveling in front of the host vehicle, a person, or a falling object is a detection target, a guardrail, a tree planted on a roadside, a tunnel, or the like is not the detection target. That is, the non-detection target includes a virtual image that is not an object and an object that is not a detection target, and the millimeter wave radar 20 once detects the detection target and the non-detection target without distinction. Therefore, hereinafter, the detected aggregate of transmission and reception points is referred to as “detection target candidate”.

The imaging section 30 acquires image data of the front of a vehicle by a camera or the like and processes the image data, thereby detecting information of an object in front of the vehicle. For example, the imaging section 30 can accurately image the size, shape, color, and the like of the object itself. On the other hand, the imaging section 30 is easily affected by an environment such as rain or fog, for example, and the accuracy of distance measurement is low. The camera of the imaging section 30 is directed in the radio-wave irradiation direction of the millimeter wave radar 20, and images the radio-wave irradiation range of the millimeter wave radar 20.

The information processing device 10 includes a data processing section 11, an extraction section 12, a coordinate transformation section 13, a database 14, an identification section 15, a memory 16, and a radar control section 17. The information processing device 10 is only required to include one or a plurality of CPUs, RAMs, ROMs, and the like.

The data processing section 11 clusters an aggregate of a plurality of transmission and reception points using detection information (the relative distance, direction, relative speed, and signal intensity) of each transmission and reception point detected by the millimeter wave radar 20 to generate a detection target candidate. Furthermore, the data processing section 11 performs image processing on the image data imaged by the imaging section 30.

The memory 16 stores data of the detection target candidate, image data, and the like processed by the data processing section 11. The database 14 stores a reference image serving as a reference for collation in order to specify a detection target. The reference image is an image of an object to be recognized as a detection target, and includes, for example, images of various automobiles, people, and the like. Furthermore, the reference image may be an image of an object to be recognized as a non-detection target. The reference image may be prepared in advance and stored in the database 14, or may be generated using image data obtained during traveling and registered in the database 14. Note that the method of determining whether or not the detection target candidate is a detection target is not particularly limited as long as the detection target can be found as well as the reference image is directly compared with the image portion of the detection target candidate as described below.

On the basis of the detection information of the detection target candidate from the millimeter wave radar 20, the coordinate transformation section 13 transforms the direction and the relative distance (polar coordinates) of the detection target candidate with respect to the millimeter wave radar 20 into coordinates of the detection target candidate on the image data. The method of coordinate transformation is not particularly limited.

The extraction section 12 extracts an image portion of the detection target candidate from the image data imaged by the imaging section 30 on the basis of the coordinates of the detection target candidate transformed by the coordinate transformation section 13. For example, in a case where a plurality of detection target candidates is detected, the extraction section 12 cuts and extracts each image portion from the image data along the contour of the plurality of detection target candidates. The extracted image portion of the detection target candidate is transferred to the identification section 15. In a case where the detection target candidate is not detected in the millimeter wave radar 20, the extraction section 12 does not extract the image portion of the detection target candidate from the image data.

The identification section 15 identifies a detection target from the image portion of the detection target candidate. At this time, the identification section 15 refers to the reference image of the detection target from the database stored in the database 14. Since the image portion of the detection target candidate is a part of the image data, it is possible to relatively accurately grasp the shape, size, color, and the like. Therefore, the identification section 15 can compare the reference image with the image portion of the detection target candidate and search for a reference image substantially equal to or similar to the detection target candidate. The identification section 15 then determines whether or not the detection target candidate is a detection target on the basis of the reference image received a hit in the search. In this manner, the identification section 15 can identify whether or not each detection target candidate is a detection target. Note that the method of determining whether or not the detection target candidate is a detection target is not particularly limited as long as the detection target can be found as well as the reference image is directly compared with the image portion of the detection target candidate. For example, a certain feature amount may be extracted from the image portion, and the detection target may be identified by a predetermined rule. The detection target may be detected using an object detection model such as Single Shot MultiBox Detector (SSD) or You Only Look Once (YOLO).

The detection information (the relative distance, direction, relative speed, and signal intensity) of the detection target candidate identified as the detection target can be applied as it is as the detection information of the detection target. Therefore, not only the image information (the shape, size, color, and the like) of the detection target but also the detection information (the relative distance, direction, relative speed, signal intensity, and the like) of the detection target are found. That is, the identification section 15 can accurately grasp the attribute, distance, and position of the detection target. The attribute indicates what the detection target is. For example, the attribute of the detection target is an automobile, a person, a bicycle, a box, or the like.

On the basis of the detection information of the detection target, the radar control section 17 controls the millimeter wave radar 20 to direct the radio-wave irradiation direction in the direction of the detection target and set the irradiation range to a narrow-band. The control circuit 23 determines the irradiation direction of the radio waves from the transmission antenna ANTt in accordance with a command from the radar control section 17, and sets the irradiation range to a narrow-band. Since the detection information of the detection target can be accurately grasped, the millimeter wave radar 20 can reliably perform beamforming on the detection target even if radio waves are transmitted in a narrow-band. By performing beamforming on the detection target, the information processing device 10 can obtain highly accurate detection information (the relative distance, direction (angle), relative speed, and the like) of the detection target. Note that the radar control section 17 may switch the radio-wave irradiation range in two stages, that is, a wide-band and a narrow-band, or in three or more stages. Furthermore, the radar control section 17 may be configured to be able to continuously change the radio-wave irradiation range.

As described above, the object detection device 100 according to the present embodiment extracts the image portion of the detection target candidate detected by the millimeter wave radar 20 from the image data, and identifies the detection target using the image portion of the detection target candidate. The object detection device 100 then performs beamforming while transmitting radio waves to the detection target in a narrow-band. As a result, it is possible to improve the detection accuracy of a distant detection target.

Next, an object detection method using the object detection device 100 will be described.

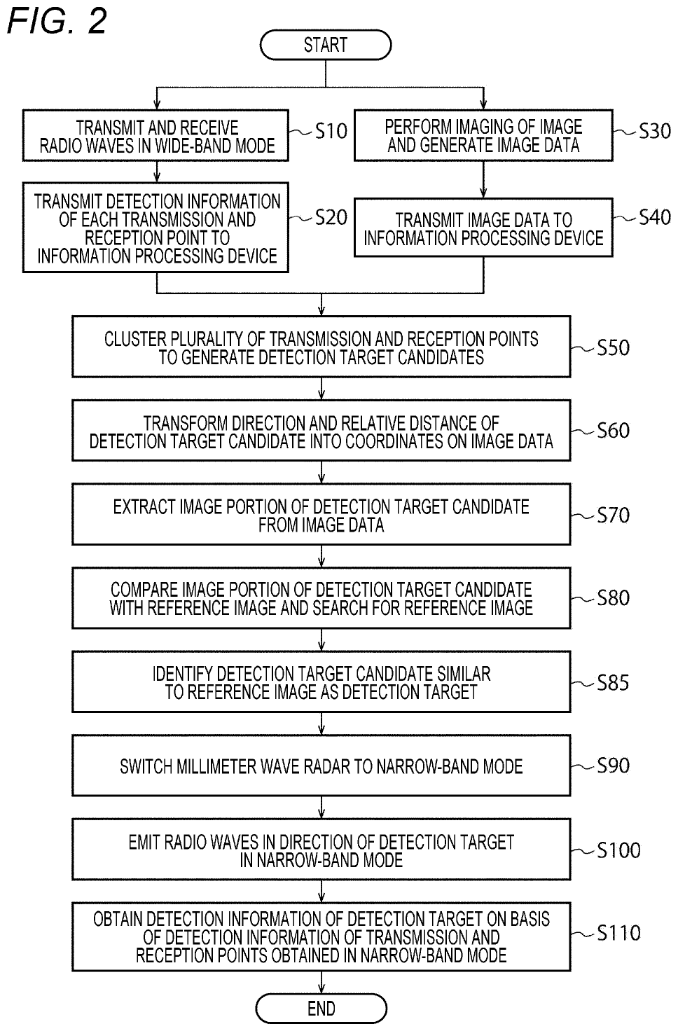

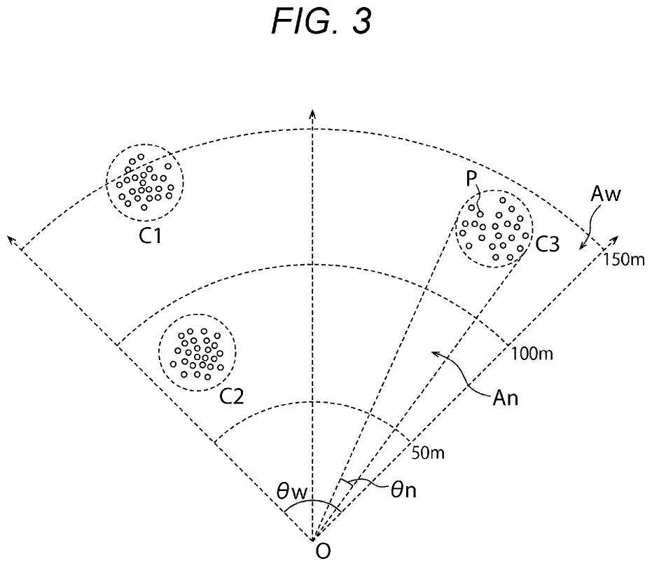

FIG. 2 is a flowchart depicting an example of an object detection method according to the present disclosure. FIG. 3 is a schematic diagram depicting an irradiation range of radio waves from the millimeter wave radar 20.

First, the millimeter wave radar 20 transmits radio waves in a wide-band mode (first mode) and receives a reflected wave (S10). The wide-band mode is a mode in which a relatively wide range (first area) is scanned with radio waves to detect a detection target candidate. For example, as depicted in FIG. 3, it is assumed that the millimeter wave radar 20 can detect an object in the range from the origin O to 150 m with the position of a host vehicle (the position of the millimeter wave radar 20) as the origin O. In the wide-band mode, the millimeter wave radar 20 scans a fan-shaped range Aw with a relatively wide angle θW and a distance of 150 m from the origin O with radio waves.

The millimeter wave radar 20 transmits detection information of each transmission and reception point to the information processing device 10 (S20). This detection information is stored in the memory 16. In parallel with the transmission and reception of radio waves, the imaging section 30 images an image of an area including a radio-wave irradiation range (first area) and generates image data (S30). This image data is transmitted to the information processing device 10 and stored in the memory 16 (S40).

Next, the data processing section 11 clusters a plurality of transmission and reception points on the basis of the detection information of each transmission and reception point to generate detection target candidates (S50). At this time, for example, in FIG. 3, a plurality of transmission and reception points P is clustered into three detection target candidates C1 to C3. Furthermore, the data processing section 11 performs image processing on the image data imaged by the imaging section 30.

Next, the coordinate transformation section 13 transforms the directions and the relative distances of the detection target candidates C1 to C3 into coordinates on the image data (S60). At this time, the directions and the relative distances of all transmission and reception points included in the detection target candidates C1 to C3 are transformed into coordinates on the image data. Alternatively, the directions and the relative distances of only the transmission and reception points located at the outer edges of the detection target candidates C1 to C3 may be transformed into coordinates on the image data. In this case, the contours of the detection target candidates C1 to C3 can be grasped in the image data, and the load of the coordinate transformation section 13 can be reduced and the coordinate transformation time can be shortened.

Next, the extraction section 12 extracts image portions of the detection target candidates C1 to C3 from the image data on the basis of the coordinates on the image data of the detection target candidates C1 to C3 (S70). At this time, the image portion of each of the detection target candidates C1 to C3 is cut from the image data.

Next, the identification section 15 compares the image portions of the detection target candidates C1 to C3 with reference images and searches for a reference image substantially equal to or similar to the detection target candidate (S80). If the reference image hits any one of the image portions of the detection target candidates C1 to C3 by the search, the identification section 15 identifies whether or not the detection target candidates C1 to C3 are detection targets on the basis of the attribute associated with the reference image. For example, if the reference image that receives a hit to be similar to the detection target candidate C3 is the detection target (for example, automobile, pedestrian, or the like), the identification section 15 identifies the detection target candidate C3 as the detection target (S85). On the other hand, if the reference image that receives a hit to be similar to the detection target candidate C3 is a non-detection target (for example, guardrail, tree planted on roadside, or the like), the identification section 15 identifies the detection target candidate C3 as a non-detection target. Alternatively, even if no reference image hits the detection target candidate C3, the identification section 15 identifies the detection target candidate C3 as the non-detection target.

Next, the radar control section 17 switches the millimeter wave radar 20 to the narrow-band mode (second mode) so as to irradiate the detection target candidate identified as the detection target with radio waves (S90). For example, in a case where the detection target candidates C1 and C2 are non-detection targets and the detection target candidate C3 is a detection target, the radar control section 17 controls the millimeter wave radar 20 in such a manner that the radio-wave irradiation direction is directed in the direction of the detection target candidate C3 and the irradiation range is set to the narrow range mode on the basis of the detection information of the detection target candidate C3. Note that in a case where there is no detection target, the radar control section 17 does not need to switch the millimeter wave radar 20 to the narrow-band mode, and may continue the wide-band mode.

Next, the millimeter wave radar 20 emits radio waves in the direction of the detection target C3 in the narrow-band mode in accordance with the instruction of the radar control section 17 (S100). The narrow-band mode is a mode in which a relatively narrow range (second area) is scanned with radio waves to detect the detection target. For example, as depicted in FIG. 3, in the narrow-band mode, the millimeter wave radar 20 scans a fan-shaped range An with a relatively narrow angle θn and a distance from the origin O to the detection target C3 with radio waves.

The millimeter wave radar 20 obtains detection information of the detection target C3 on the basis of detection information of transmission and reception points obtained in the narrow-band mode (S110). As a result, the millimeter wave radar 20 can obtain detection information by irradiating the minimum necessary detection target C3 with radio waves without irradiating the non-detection targets C1 and C2 with radio waves. As a result, it is possible to accurately detect the detection target, reduce the load of the information processing device 10, and shorten the detection time (detection cycle) of the detection target C3.

After the mode is switched from the wide-band mode to the narrow-band mode, the timing when the mode returns from the narrow-band mode to the wide-band mode may be any time point. For example, the object detection device 100 may return from the narrow-band mode to the wide-band mode when a predetermined period has elapsed after being switched from the wide-band mode to the narrow-band mode. Furthermore, the object detection device 100 may return from the narrow-band mode to the wide-band mode when the detection target is no longer detected in the narrow-band mode. The object detection device 100 may perform steps S10 to S85 again in the wide-band mode and update the detection target.

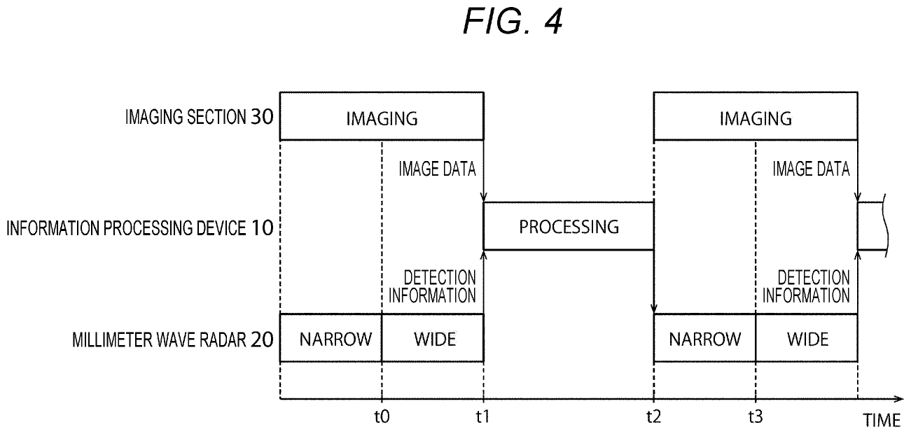

FIG. 4 is a timing chart depicting a performance pattern of a wide-band mode and a narrow-band mode. The horizontal axis in FIG. 4 indicates time. Furthermore, FIG. 4 depicts the operation contents of the information processing device 10, the millimeter wave radar 20, and the imaging section 30.

First, at t0, the millimeter wave radar 20 transmits and receives radio waves in the wide-band mode. Detection information of transmission and reception points is transmitted to the information processing device 10. Meanwhile, the imaging section 30 images an area including a radio-wave irradiation range (first area) in the wide-band mode and generates image data. The image data is also transmitted to the information processing device 10.

When the detection information and the image data from t0 to t1 are transmitted to the information processing device 10, the information processing device 10 clusters a plurality of transmission and reception points on the basis of the detection information of the transmission and reception points to generate a detection target candidate from t1 to t2. Furthermore, the information processing device 10 transforms the coordinates of the detection target candidate into coordinate on the image data, and extracts the image portion of the detection target candidate from the image data. Moreover, the information processing device 10 identifies whether or not the detection target candidate is a detection target. From t1 to t2, these pieces of data processing are performed.

From t2 to t3, the millimeter wave radar 20 switches the mode from the wide-band mode to the narrow-band mode, and transmits and receives radio waves to and from the detection target in the narrow-band mode. In the narrow-band mode, since the identification process of the detection target using the image data is not performed, the imaging section 30 does not necessarily need to image the detection target.

Thereafter, the object detection device 100 repeatedly performs the operations of t0 to t3. That is, the radar control section 17 alternately repeats the wide-band mode and the narrow-band mode. The radar control section 17 controls the millimeter wave radar 20 so as to irradiate the detection target identified in the wide-band mode with radio waves in the next narrow-band mode. As a result, even if the situation around the host vehicle changes, the object detection device 100 can sequentially update the detection target in accordance with the change in the situation and appropriately change the radio-wave irradiation direction in the narrow-band mode. It is only required that the time from t0 to t3 (one cycle of the wide-band mode and the narrow-band mode) is set depending on the speed of the change in the surrounding situation. For example, since it is not necessary to consider traveling and rushing out of a pedestrian and a bicycle on an uncongested highway, the time from t0 to t3 can be made relatively long. On the other hand, in a general road with many people, it is necessary to consider traveling and rushing out of a pedestrian and a bicycle. Therefore, it is necessary to set the time from t0 to t3 to be relatively short and frequently update the detection target.

As described above, the object detection device 100 according to the present disclosure specifies the detection target from the detection target candidates using the image portion of the detection target candidate by using the detection information of the detection target candidates detected by the millimeter wave radar 20 and the image data captured by the imaging section 30. The object detection device 100 then feeds back the detection information of the detection target to the millimeter wave radar 20, and enables accurate detection of the detection target even in the narrow-band mode. The object detection device 100 can perform beamforming while transmitting radio waves to the detection target in the narrow-band mode, and can improve the detection accuracy of a distant detection target.

### Second Embodiment

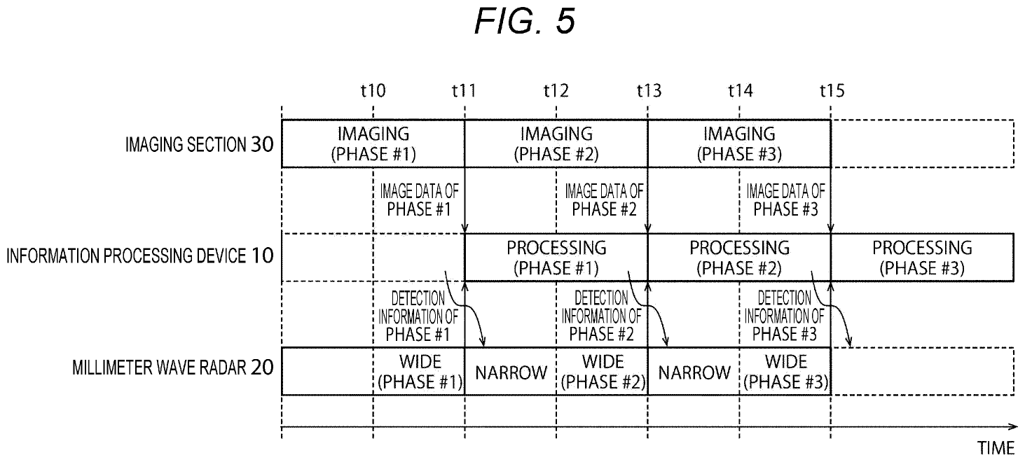

FIG. 5 is a timing chart depicting another performance pattern of a wide-band mode and a narrow-band mode in a second embodiment. In the performance pattern of FIG. 5, in parallel with the period in which the information processing device 10 performs data processing (steps S50 to S90 in FIG. 3), the millimeter wave radar 20 transmits and receives radio waves to generate detection information of detection target candidates, and the imaging section 30 generates image data.

For example, from t10 to t11, the millimeter wave radar 20 transmits and receives radio waves in the wide-band mode. Detection information of transmission and reception points is transmitted to the information processing device 10. Meanwhile, the imaging section 30 images an area including a radio-wave irradiation range (first area) in the wide-band mode and generates image data. The image data is also transmitted to the information processing device 10.

When the detection information and the image data are transmitted to the information processing device 10, from t11 to t13, the information processing device 10 generates a detection target candidate on the basis of the detection information of the transmission and reception points, and identifies whether or not the detection target candidate is a detection target. From t11 to t13, these pieces of data processing are performed. The data processing from t11 to t13 is processing of the detection information and the image data (first phase data) obtained from t10 to t11.

Note that, in a case where the information processing device 10 performs data processing before t11, the millimeter wave radar 20 switches the mode from the wide-band mode to the narrow-band mode in parallel with the data processing of the information processing device 10 from t11 to t12, and transmits and receives radio waves to and from the detection target identified before t11.

From t12 to t13, the information processing device 10 continues the data processing of the first phase data. The millimeter wave radar 20 returns from the narrow-band mode to the wide-band mode, and generates detection information of transmission and reception points in order to update the detection target. At t13, the detection information of transmission and reception points is transmitted to the information processing device 10. Furthermore, the imaging section 30 images an area including a radio-wave irradiation range (first area) in the wide-band mode and generates image data. At t13, the image data is transmitted to the information processing device 10. At this time, the detection information and the image data to be transmitted are second phase data.

When the second phase data is transmitted to the information processing device 10 at t13, the information processing device 10 similarly identifies the detection target on the basis of the second phase data from t13 to t15. The data processing from t13 to t15 is data processing of the second phase data.

From t13 to t14, in parallel with the data processing of the information processing device 10, the millimeter wave radar 20 switches the mode from the wide-band mode to the narrow-band mode, and transmits and receives radio waves to and from the detection target obtained using the first phase data. From t13 to t14, the imaging section 30 also generates image data in parallel with the data processing of the information processing device 10.

From t14 to t15, the information processing device 10 continues the data processing of the second phase data. The millimeter wave radar 20 returns from the narrow-band mode to the wide-band mode, and generates detection information of transmission and reception points in order to update the detection target. At t15, the detection information of the transmission and reception points is transmitted to the information processing device 10. Furthermore, the imaging section 30 images an area including a radio-wave irradiation range (first area) in the wide-band mode and generates image data. At t15, the image data is transmitted to the information processing device 10. At this time, the detection information and the image data to be transmitted are third phase data.

When the third phase data is transmitted to the information processing device 10 at t15, the information processing device 10 similarly identifies the detection target on the basis of the third phase data after t15. The data processing after t15 is data processing of the third phase data.

After t15, in parallel with the data processing of the information processing device 10, the millimeter wave radar 20 switches the mode from the wide-band mode to the narrow-band mode, and transmits and receives radio waves to and from the detection target obtained using the second phase data. After t15, the imaging section 30 also generates image data in parallel with the data processing of the information processing device 10.

As described above, the object detection device 100, for example, sets t10 to t12 as one cycle, alternately and continuously performs the detection operation in the narrow-band mode and the detection operation in the wide-band mode, and performs the data processing in parallel therewith. At this time, the data processing in the object detection device 100 is performed using the detection information of the detection target candidate of the previous phase generated one cycle before and the image data. As a result, the object detection device 100 can seamlessly and continuously perform the detection operation in the narrow-band mode and the detection operation in the wide-band mode. As a result, the object detection time can be shortened while improving the object detection accuracy.

The technology according to the present disclosure (present technology) can be applied to various products. For example, the technology according to the present disclosure may be achieved as a device mounted on any type of mobile bodies such as an automobile, an electric vehicle, a hybrid electric vehicle, a motorcycle, a bicycle, personal mobility, an airplane, a drone, a ship, and a robot.

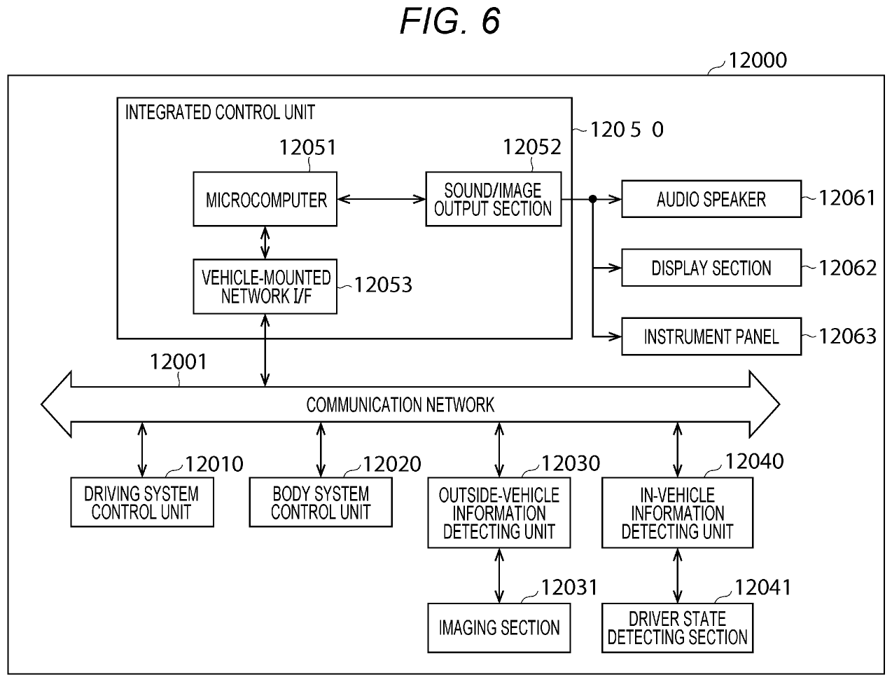

FIG. 6 is a block diagram depicting an example of schematic configuration of a vehicle control system as an example of a mobile body control system to which the technology according to an embodiment of the present disclosure can be applied.

The vehicle control system 12000 includes a plurality of electronic control units connected to each other via a communication network 12001. In the example depicted in FIG. 6, the vehicle control system 12000 includes a driving system control unit 12010, a body system control unit 12020, an outside-vehicle information detecting unit 12030, an in-vehicle information detecting unit 12040, and an integrated control unit 12050. In addition, a microcomputer 12051, a sound/image output section 12052, and a vehicle-mounted network interface (I/F) 12053 are illustrated as a functional configuration of the integrated control unit 12050.

The driving system control unit 12010 controls the operation of devices related to the driving system of the vehicle in accordance with various kinds of programs. For example, the driving system control unit 12010 functions as a control device for a driving force generating device for generating the driving force of the vehicle, such as an internal combustion engine, a driving motor, or the like, a driving force transmitting mechanism for transmitting the driving force to wheels, a steering mechanism for adjusting the steering angle of the vehicle, a braking device for generating the braking force of the vehicle, and the like.

The body system control unit 12020 controls the operation of various kinds of devices provided to a vehicle body in accordance with various kinds of programs. For example, the body system control unit 12020 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 12020. The body system control unit 12020 receives these input radio waves or signals, and controls a door lock device, the power window device, the lamps, or the like of the vehicle.

The outside-vehicle information detecting unit 12030 detects information about the outside of the vehicle including the vehicle control system 12000. For example, the outside-vehicle information detecting unit 12030 is connected with an imaging section 12031. The outside-vehicle information detecting unit 12030 makes the imaging section 12031 image an image of the outside of the vehicle, and receives the imaged image. On the basis of the received image, the outside-vehicle information detecting unit 12030 may perform processing of detecting an object such as a human, a vehicle, an obstacle, a sign, a character on a road surface, or the like, or processing of detecting a distance thereto. The object detection device 100 or the information processing device 10 according to the present disclosure may be provided in the outside-vehicle information detecting unit 12030.

The imaging section 12031 is an optical sensor that receives light, and which outputs an electric signal corresponding to a received light amount of the light. The imaging section 12031 can output the electric signal as an image, or can output the electric signal as information about a measured distance. In addition, the light received by the imaging section 12031 may be visible light, or may be invisible light such as infrared rays or the like. The imaging section 30 according to the present disclosure may be the imaging section 12031, or may be provided separately from the imaging section 12031. The object detection device 100 or the information processing device 10 according to the present disclosure may be provided in the imaging section 12031.

The in-vehicle information detecting unit 12040 detects information about the inside of the vehicle. The in-vehicle information detecting unit 12040 is, for example, connected with a driver state detecting section 12041 that detects the state of a driver. The driver state detecting section 12041, for example, includes a camera that images the driver. On the basis of detection information input from the driver state detecting section 12041, the in-vehicle information detecting unit 12040 may calculate a degree of fatigue of the driver or a degree of concentration of the driver, or may determine whether the driver is dozing.

The microcomputer 12051 can calculate a control target value for the driving force generating device, the steering mechanism, or the braking device on the basis of the information about the inside or outside of the vehicle which information is obtained by the outside-vehicle information detecting unit 12030 or the in-vehicle information detecting unit 12040, and output a control command to the driving system control unit 12010. For example, the microcomputer 12051 can perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like.

In addition, the microcomputer 12051 can perform cooperative control intended for automated driving, which makes the vehicle to travel automatedly without depending on the operation of the driver, or the like, by controlling the driving force generating device, the steering mechanism, the braking device, or the like on the basis of the information about the outside or inside of the vehicle which information is obtained by the outside-vehicle information detecting unit 12030 or the in-vehicle information detecting unit 12040.

In addition, the microcomputer 12051 can output a control command to the body system control unit 12020 on the basis of the information about the outside of the vehicle which information is obtained by the outside-vehicle information detecting unit 12030. For example, the microcomputer 12051 can perform cooperative control intended to prevent a glare by controlling the headlamp so as to change from a high beam to a low beam, for example, in accordance with the position of a preceding vehicle or an oncoming vehicle detected by the outside-vehicle information detecting unit 12030.

The sound/image output section 12052 transmits an output signal of at least one of a sound and an image to an output device capable of visually or auditorily notifying information to an occupant of the vehicle or the outside of the vehicle. In the example of FIG. 6, an audio speaker 12061, a display section 12062, and an instrument panel 12063 are illustrated as the output device. The display section 12062 may, for example, include at least one of an on-board display and a head-up display.

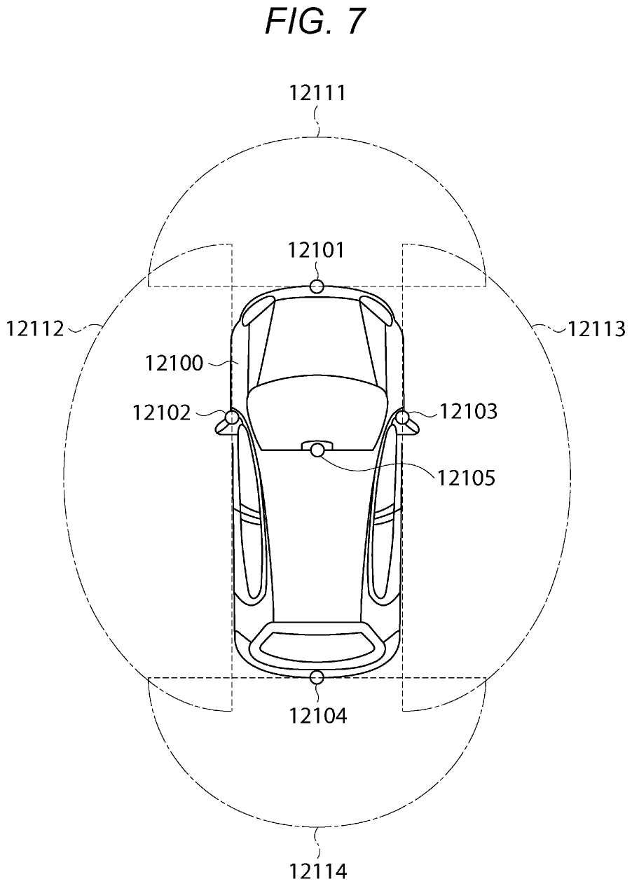

FIG. 7 is a diagram depicting an example of the installation position of the imaging section 12031.

In FIG. 7, a vehicle 12100 includes imaging sections 12101, 12102, 12103, 12104, and 12105 as the imaging section 12031. In addition, the vehicle 12100 includes the object detection device 100.

The imaging sections 12101, 12102, 12103, 12104, and 12105 are, for example, disposed at positions on a front nose, sideview mirrors, a rear bumper, and a back door of the vehicle 12100 as well as a position on an upper portion of a windshield within the interior of the vehicle. The imaging section 12101 provided to the front nose and the imaging section 12105 provided to the upper portion of the windshield within the interior of the vehicle obtain mainly an image of the front of the vehicle 12100. The imaging sections 12102 and 12103 provided to the sideview mirrors obtain mainly an image of the sides of the vehicle 12100. The imaging section 12104 provided to the rear bumper or the back door obtains mainly an image of the rear of the vehicle 12100. The front images acquired by the imaging sections 12101 and 12105 are mainly used for detecting a preceding vehicle, a pedestrian, an obstacle, a traffic signal, a traffic sign, a lane, or the like.

Incidentally, FIG. 7 depicts an example of imaging ranges of the imaging sections 12101 to 12104. An imaging range 12111 represents the imaging range of the imaging section 12101 provided to the front nose. Imaging ranges 12112 and 12113 respectively represent the imaging ranges of the imaging sections 12102 and 12103 provided to the sideview mirrors. An imaging range 12114 represents the imaging range of the imaging section 12104 provided to the rear bumper or the back door. A bird's-eye image of the vehicle 12100 as viewed from above is obtained by superimposing image data imaged by the imaging sections 12101 to 12104, for example.

At least one of the imaging sections 12101 to 12104 may have a function of obtaining distance information. For example, at least one of the imaging sections 12101 to 12104 may be a stereo camera constituted of a plurality of imaging elements, or may be an imaging element having pixels for phase difference detection.

For example, the microcomputer 12051 can determine a distance to each three-dimensional object within the imaging ranges 12111 to 12114 and a temporal change in the distance (relative speed with respect to the vehicle 12100) on the basis of the distance information obtained from the imaging sections 12101 to 12104, and thereby extract, as a preceding vehicle, a nearest three-dimensional object in particular that is present on a traveling path of the vehicle 12100 and which travels in substantially the same direction as the vehicle 12100 at a predetermined speed (for example, equal to or more than 0 km/hour). Further, the microcomputer 12051 can set a following distance to be maintained in front of a preceding vehicle in advance, and perform automatic brake control (including following stop control), automatic acceleration control (including following start control), or the like. It is thus possible to perform cooperative control intended for automated driving that makes the vehicle travel automatedly without depending on the operation of the driver or the like.

For example, the microcomputer 12051 can classify three-dimensional object data on three-dimensional objects into three-dimensional object data of a two-wheeled vehicle, a standard-sized vehicle, a large-sized vehicle, a pedestrian, a utility pole, and other three-dimensional objects on the basis of the distance information obtained from the imaging sections 12101 to 12104, extract the classified three-dimensional object data, and use the extracted three-dimensional object data for automatic avoidance of an obstacle. For example, the microcomputer 12051 identifies obstacles around the vehicle 12100 as obstacles that the driver of the vehicle 12100 can recognize visually and obstacles that are difficult for the driver of the vehicle 12100 to recognize visually. Then, the microcomputer 12051 determines a collision risk indicating a risk of collision with each obstacle. In a situation in which the collision risk is equal to or higher than a set value and there is thus a possibility of collision, the microcomputer 12051 outputs a warning to the driver via the audio speaker 12061 or the display section 12062, and performs forced deceleration or avoidance steering via the driving system control unit 12010. The microcomputer 12051 can thereby assist in driving to avoid collision.

At least one of the imaging sections 12101 to 12104 may be an infrared camera that detects infrared rays. The microcomputer 12051 can, for example, recognize a pedestrian by determining whether or not there is a pedestrian in imaged images of the imaging sections 12101 to 12104. Such recognition of a pedestrian is, for example, performed by a procedure of extracting characteristic points in the imaged images of the imaging sections 12101 to 12104 as infrared cameras and a procedure of determining whether or not it is the pedestrian by performing pattern matching processing on a series of characteristic points representing the contour of the object. When the microcomputer 12051 determines that there is a pedestrian in the imaged images of the imaging sections 12101 to 12104, and thus recognizes the pedestrian, the sound/image output section 12052 controls the display section 12062 so that a square contour line for emphasis is displayed so as to be superimposed on the recognized pedestrian. The sound/image output section 12052 may also control the display section 12062 so that an icon or the like representing the pedestrian is displayed at a desired position.

As described above, the technology according to the present disclosure can be applied to, for example, the outside-vehicle information detecting unit 12030. Specifically, the object detection device 100 described above can be mounted in the outside-vehicle information detecting unit 12030. By applying the technology according to the present disclosure to the imaging section 12031, accurate distance information can be obtained in an environment of a wide brightness dynamic range, and the functionality and safety of the vehicle 12100 can be improved.

Note that the present technology can also have the following configurations.

(1)

An object detection device including:

a radar that transmits a radio wave to a first area and detects a detection target candidate present in the first area;

an imaging section that images the first area and generates image data;

an identification section that identifies a detection target from a plurality of the detection target candidates on the basis of the image data; and

a radar control section that controls the radar so as to irradiate a second area including the detection target and narrower than the first area with a radio wave.

(2)

The object detection device according to (1), in which the radar transmits a radio wave to the first area and detects a transmission and reception point of a reflected radio wave, and

the object detection device further including a data processing section that clusters the transmission and reception point to generate the detection target candidate.

(3)

The object detection device according to (1) or (2) further including:

a coordinate transformation section that transforms a direction and a relative distance of the detection target candidate with respect to the radar into coordinates of the detection target candidate on the image data; and

an extraction section that extracts an image portion of the detection target candidate from the image data on the basis of coordinates of the detection target candidate on the image data, in which

the identification section identifies whether or not the detection target candidate is the detection target using the image portion of the detection target candidate extracted, and

the radar control section controls the radar in such a manner that the detection target is located in the second area on the basis of a direction and a distance of the detection target candidate determined as the detection target.

(4)

The object detection device according to (3) further including a database that stores a reference image serving as a reference for collation in order to specify the detection target, in which

the identification section compares an image portion of the detection target candidate extracted with the reference image and identifies the detection target candidate having a similar reference image as the detection target.

(5)

The object detection device according to any one of (1) to (4), in which the radar control section controls the radar to be switched between a first mode in which the first area is irradiated with a radio wave and a second mode in which the second area is irradiated with a radio wave.

(6)

The object detection device according to (5), in which the radar control section controls the radar so as to irradiate the detection target identified in the first mode with a radio wave in the second mode next to the first mode.

(7)

The object detection device according to (5) or (6), in which the radar control section alternately repeats the first mode and the second mode.

(8)

An information processing device including:

an identification section that identifies, on the basis of a detection target candidate detected by transmitting a radio wave from a radar to a first area and image data obtained from an imaging section, a detection target from a plurality of the detection target candidates; and

a radar control section that controls the radar so as to irradiate a second area including the detection target and narrower than the first area with a radio wave.

(9)

The information processing device according to (8) further including a data processing section that transmits a radio wave from the radar to the first area and clusters a transmission and reception point of a reflected radio wave to generate the detection target candidate.

(10)

The information processing device according to (8) or (9) further including:

a coordinate transformation section that transforms a direction and a relative distance of the detection target candidate with respect to the radar into coordinates of the detection target candidate on the image data; and

an extraction section that extracts an image portion of the detection target candidate from the image data on the basis of coordinates of the detection target candidate on the image data, in which

the identification section identifies whether or not the detection target candidate is the detection target using the image portion of the detection target candidate extracted, and

the radar control section controls the radar in such a manner that the detection target is located in the second area on the basis of a direction and a distance of the detection target candidate determined as the detection target.

(11)

The information processing device according to (10) further including a database that stores a reference image serving as a reference for collation in order to specify the detection target, in which

the identification section compares an image portion of the detection target candidate extracted with the reference image and identifies the detection target candidate having a similar reference image as the detection target.

(12)

The information processing device according to any one of (8) to (11), in which the radar control section controls the radar to be switched between a first mode in which the first area is irradiated with a radio wave and a second mode in which the second area is irradiated with a radio wave.

(13)

The information processing device according to (12), in which the radar control section controls the radar so as to irradiate the detection target identified in the first mode with a radio wave in the second mode next to the first mode.

(14)

The information processing device according to (12) or (13), in which the radar control section alternately repeats the first mode and the second mode.

(15)

An object detection method using an object detection device that includes a radar that transmits a radio wave, an imaging section that images an image, and an information processing device that processes detection information from the radar and image data from the imaging section to control the radar, the object detection method including:

transmitting a radio wave to a first area and detecting a detection target candidate present in the first area;

imaging the first area and generating image data;

identifying a detection target from a plurality of the detection target candidates on the basis of the image data; and

controlling the radar so as to irradiate a second area including the detection target and narrower than the first area with a radio wave.

(16)

The object detection method according to (15), in which detecting the detection target candidate includes

transmitting a radio wave to the first area and detecting a transmission and reception point of a reflected radio wave, and

clustering the transmission and reception point to generate the detection target candidate.

(17)

The object detection method according to (15) or (16), in which

identifying the detection target includes

transforming a direction and a relative distance of the detection target candidate with respect to the radar into coordinates of the detection target candidate on the image data,

extracting an image portion of the detection target candidate from the image data on the basis of coordinates of the detection target candidate on the image data, and

identifying whether or not the detection target candidate is the detection target using the image portion of the detection target candidate extracted, and

controlling the radar includes controlling the radar in such a manner that the detection target is located in the second area on the basis of a direction and a distance of the detection target candidate determined as the detection target.

(18)

The object detection method according to (17), in which the object detection device further includes a database that stores a reference image serving as a reference for collation in order to specify the detection target, and

identifying the detection target includes

comparing an image portion of the detection target candidate extracted with the reference image, and

identifying the detection target candidate having a similar reference image as the detection target.

(19)

The object detection method according to any one of (15) to (18), in which controlling the radar includes controlling the radar to be periodically and alternately switched between a first mode in which the first area is irradiated with a radio wave and a second mode in which the second area is irradiated with a radio wave.

(20)

The object detection method according to (19), in which controlling the radar includes irradiating the detection target identified in the first mode with a radio wave in the second mode next to the first mode.

Aspects of the present disclosure are not limited to the individual embodiments described above, but include various modifications that can be conceived by those skilled in the art, and the effects of the present disclosure are not limited to the contents described above. That is, various additions, modifications, and partial deletions can be made without departing from the conceptual idea and spirit of the present disclosure derived from the contents defined in the claims and equivalents thereof.

### REFERENCE SIGNS LIST

100 Object detection device
10 Information processing device
20 Millimeter wave radar
30 Imaging section
21 Transmission circuit
22 Reception circuit
23 Control circuit
ANTt Transmission antenna
ANTr Reception antenna
11 Data processing section
12 Extraction section
13 Coordinate transformation section
14 Database
15 Identification section
16 Memory
17 Radar control section

1. An object detection device comprising:
a radar that transmits a radio wave to a first area and detects a detection target candidate present in the first area;
an imaging section that images the first area and generates image data;
an identification section that identifies a detection target from a plurality of the detection target candidates on a basis of the image data; and
a radar control section that controls the radar so as to irradiate a second area including the detection target and narrower than the first area with a radio wave.

2. The object detection device according to claim 1, wherein the radar transmits a radio wave to the first area and detects a transmission and reception point of a reflected radio wave, and
the object detection device further comprising a data processing section that clusters the transmission and reception point to generate the detection target candidate.

3. The object detection device according to claim 1 further comprising:
a coordinate transformation section that transforms a direction and a relative distance of the detection target candidate with respect to the radar into coordinates of the detection target candidate on the image data; and
an extraction section that extracts an image portion of the detection target candidate from the image data on a basis of coordinates of the detection target candidate on the image data, wherein
the identification section identifies whether or not the detection target candidate is the detection target using the image portion of the detection target candidate extracted, and
the radar control section controls the radar in such a manner that the detection target is located in the second area on a basis of a direction and a distance of the detection target candidate determined as the detection target.

4. The object detection device according to claim 3 further comprising a database that stores a reference image serving as a reference for collation in order to specify the detection target, wherein
the identification section compares an image portion of the detection target candidate extracted with the reference image and identifies the detection target candidate having a similar reference image as the detection target.

5. The object detection device according to claim 1, wherein the radar control section controls the radar to be switched between a first mode in which the first area is irradiated with a radio wave and a second mode in which the second area is irradiated with a radio wave.

6. The object detection device according to claim 5, wherein the radar control section controls the radar so as to irradiate the detection target identified in the first mode with a radio wave in the second mode next to the first mode.

7. The object detection device according to claim 5, wherein the radar control section alternately repeats the first mode and the second mode.

8. An information processing device comprising:
an identification section that identifies, on a basis of a detection target candidate detected by transmitting a radio wave from a radar to a first area and image data obtained from an imaging section, a detection target from a plurality of the detection target candidates; and
a radar control section that controls the radar so as to irradiate a second area including the detection target and narrower than the first area with a radio wave.

9. The information processing device according to claim 8 further comprising a data processing section that transmits a radio wave from the radar to the first area and clusters a transmission and reception point of a reflected radio wave to generate the detection target candidate.

10. The information processing device according to claim 8 further comprising:
a coordinate transformation section that transforms a direction and a relative distance of the detection target candidate with respect to the radar into coordinates of the detection target candidate on the image data; and
an extraction section that extracts an image portion of the detection target candidate from the image data on a basis of coordinates of the detection target candidate on the image data, wherein
the identification section identifies whether or not the detection target candidate is the detection target using the image portion of the detection target candidate extracted, and
the radar control section controls the radar in such a manner that the detection target is located in the second area on a basis of a direction and a distance of the detection target candidate determined as the detection target.

11. The information processing device according to claim 10 further comprising a database that stores a reference image serving as a reference for collation in order to specify the detection target, wherein
the identification section compares an image portion of the detection target candidate extracted with the reference image and identifies the detection target candidate having a similar reference image as the detection target.

12. The information processing device according to claim 8, wherein the radar control section controls the radar to be switched between a first mode in which the first area is irradiated with a radio wave and a second mode in which the second area is irradiated with a radio wave.

13. The information processing device according to claim 12, wherein the radar control section controls the radar so as to irradiate the detection target identified in the first mode with a radio wave in the second mode next to the first mode.

14. The information processing device according to claim 12, wherein the radar control section alternately repeats the first mode and the second mode.

15. An object detection method using an object detection device that includes a radar that transmits a radio wave, an imaging section that images an image, and an information processing device that processes detection information from the radar and image data from the imaging section to control the radar, the object detection method comprising:
transmitting a radio wave to a first area and detecting a detection target candidate present in the first area;
imaging the first area and generating image data;
identifying a detection target from a plurality of the detection target candidates on a basis of the image data; and
controlling the radar so as to irradiate a second area including the detection target and narrower than the first area with a radio wave.

16. The object detection method according to claim 15, wherein detecting the detection target candidate includes
transmitting a radio wave to the first area and detecting a transmission and reception point of a reflected radio wave, and
clustering the transmission and reception point to generate the detection target candidate.

17. The object detection method according to claim 15, wherein
identifying the detection target includes
transforming a direction and a relative distance of the detection target candidate with respect to the radar into coordinates of the detection target candidate on the image data,
extracting an image portion of the detection target candidate from the image data on a basis of coordinates of the detection target candidate on the image data, and
identifying whether or not the detection target candidate is the detection target using the image portion of the detection target candidate extracted, and
controlling the radar includes controlling the radar in such a manner that the detection target is located in the second area on a basis of a direction and a distance of the detection target candidate determined as the detection target.

18. The object detection method according to claim 17, wherein the object detection device further includes a database that stores a reference image serving as a reference for collation in order to specify the detection target, and
identifying the detection target includes
comparing an image portion of the detection target candidate extracted with the reference image, and
identifying the detection target candidate having a similar reference image as the detection target.

19. The object detection method according to claim 15, wherein controlling the radar includes controlling the radar to be periodically and alternately switched between a first mode in which the first area is irradiated with a radio wave and a second mode in which the second area is irradiated with a radio wave.

20. The object detection method according to claim 19, wherein controlling the radar includes irradiating the detection target identified in the first mode with a radio wave in the second mode next to the first mode.
